(19) United States
(12) Patent Application Publication
(10) Pub. No.: US 2002/0152013 A1
(43) Pub. Date: Oct. 17, 2002

(54) Method for positioning a closing surface which is actuated by an external force

(76) Inventors: Norbert Knab, Appenweier (DE); Karlheinz Lunghard, Gernsbach (DE); Patric Kahles, Buehl (DE)

Correspondence Address: Striker Striker & Stenby, 103 East Neck Road, Huntington, NY, 11743, US

(21) Appl. No.: 10/048,203

(22) PCT Filed: May 16, 2001
(86) PCT No.: PCT/DE01/01845

(30) Foreign Application Priority Data
May 31, 2000 (DE) 100 26 991.5

(51) Int. Cl. G06F 7/00

(52) U.S. Cl. 701/49

(57) ABSTRACT

The invention is based on a method for the contactless approaching of an upper stop position (A) outfitted with a seal (5) by a window pane (1) of a motor vehicle actuated by external force. When an upper window-pane edge (2) approaches the stop position (A), a control signal is generated by a control unit (26), by way of which the electric drive is switched off in a shutoff position (11) pₐ, and/or its driving direction is reversed, so that the upper window-pane edge (2) comes to a standstill at a zero position (10) p₀. When the window pane (1) approaches the stop position (A), system parameters (S₁ . . . Sₙ) are detected by sensors (27) and stored in a memory (28). A system state SZ (S₁-Sₙ) dependent on the system parameters (S₁ . . . Sₙ) is read out with the shutoff position (11) pₐ from a characteristic diagram. A difference ΔSZ is determined by comparing the respective current system states (SZ_{cur} (S₁-Sₙ) and the reference system state SZ_{ref} (S₁ . . . Sₙ) stored in the memory (28). A new shutoff position (11.1) p_{anew} is calculated based on the deviation ΔSZ determined.

### TECHNICAL FIELD

The invention is based on a method for positioning a closing face actuated by external force. Electrically actuated window lifters and sunroofs are used today more and more in motor vehicles of all types. Their electric drives ensure safe closure of the roof or window faces by their forward motion into a mechanical end position. The mechanical end position can vary as a result of external influences, so that the point in time when the closed position is reached can shift.

### PRIOR ART

In the case of adjusting systems such as window lifting systems or sunroof drives, a safe closure of the face to be closed is indispensible, so that the passenger compartment of a motor vehicle is reliably protected against break-in and theft, for example. For this purpose, the closing system is moved into its mechanically limited end position during closing. A detection of underspeed, torque or current usually serves as the shutoff criterium. As soon as a specified limit value is exceeded for a defined time, the electric drive of the face to be closed is shut down. In order to ensure safe closure of the face to be closed, the limit values must be selected appropriately high, however. This results in a high mechanical load of the components used, such as window lifters, doors, motors, etc., the dimensioning and wear of which are to be estimated appropriately high.

Furthermore, the upper stop is used as reference position in window lifting systems with closing force limitation. Based on this reference position, important data such as the safety range limits such as the 4 mm and the 200 mm range of the closing system are determined, for example. By means of the repeated approaching of the actual upper stop, this reference position is updated constantly within certain tolerances. In this fashion, any changes in the system mechanics that may occur are detected and updated.

In current applications of electric actuations for window faces or sunroofs, it must be taken into account that, for reasons of weight, the sheet metal used in the automotive industry in the door and roof region is becoming thinner and thinner. A mechanical blocking by moving the face to be closed against its mechanical stop would result in a twisting and a distortion—visible from the outside—of the sheet metal faces, which is highly undesired.

DE 195 27 456 A1 discloses a method for positioning a part. When at least one of the end positions is reached the first time, the position of the drive is detected and stored. The next time the part approaches the end position, the drive is stopped before the end position is reached, or its driving direction is reversed.

DE 196 32 910 C1 concerns a method for the contactless approaching of the lower stop position of a window pane of a motor vehicle actuated by external force. The movement of the window pane by the drive can be divided into two phases; in the second phase of the adjusting motion, an expected slowing-down path is calculated based on the rate of motion of the window pane and/or the operating voltage of the electric drive.

### PRESENTATION OF THE INVENTION

The advantages that can be achieved with the method according to the invention lie in the fact that the electric drive for reaching the actual upper stop is stopped. Despite premature shutoff, the closing safety of the faces to be closed is ensured. Using the method proposed according to the invention, the stressing of the electric drive and the mechanical components is reduced to an indispensible minimum, because twisting states caused by closing faces hitting mechanical stops without being braked are avoided. As a result, a considerable increase in the long-term robustness of an electrically actuatable closing system can be achieved. Since the mechanical loads on the closing system are now drastically reduced, a lighter dimensioning of the elements and components implementing the sliding motion is also possible. A temperature increase that is undesired and that limits the usability of the electric drive is also ruled out, because the drive is shut down in good time before the mechanical stop is reached, and the electric drive is switched off in good time. The critical range, that is, the 4 mm-range shortly before the mechanical stop is reached, is calculated and adjusted, if necessary, based on the current system state and the system data that were already determined.

By means of the calculation of a new shutoff position—newly carried out constantly in the method according to the invention—derived with consideration for the previous shutoff position in each case, a shutdown at the right time before complete immersion in the seal that may surround a closing face can be implemented at the electric drive of the face to be closed.

### DRAWING

The invention will be explained in greater detail hereinafter using the drawing.

FIG. 1 shows a window pane moved into a seal up to the current actual zero point,

FIG. 2 shows a moving-in situation of a window pane with increasing immersion depth into a seal surrounding the window pane,

FIG. 3 shows a moving-in situation of a window pane with decreasing immersion depth, and

FIG. 4 shows a calculation routine running in the control unit for determining a new shutoff position for the electric drive of the face to be closed.

### VARIANTS OF THE EMBODIMENT

FIG. 1 shows the representation of a window pane moved into a seal up to the current actual zero point.

The upper edge 2 of a closing face 1—such as a window pane—to be closed and that can be moved by means of an electric drive, enters a seal 5 that can be embedded in a door frame 4 of a motor vehicle door. The upper edge 2 of the window pane 1 is located in the current actual zero point p₂. The physical, reachable—although only with considerable deformation of the door seal 5—zero point p₁ is labelled with reference symbol 9.

The electric drive moves the window pane 1 in the direction of the arrow 8—drawn in—into the inlet slants 12, 13 provided on both sides of the exterior faces 3 of the window pane 1. Reference numeral 11 indicates the shutoff position pₐ, in which the electric drive of the window pane 1 is shut down in such timely fashion that the upper edge 2 of the window pane 1 enters the seal 5 of the door frame 4, closing reliably.

The determination of a safe shutoff position 11, pₐ, in which a safe closure of the closing face 1 is ensured, is determined empirically. An immersion depth is determined into which the seal 5 surrounding the closing face 1 [verb missing] as a function of the closing system parameters such as motor torque of the electric drive, temperature, seal geometry, motor voltage, window-pane surface, seal friction, kinetic system energy and door geometry, for example. The immersion depth of the window pane 1 can be empirically determined from these parameters using a series of measurements. After determination, this interrelationship is stored in a computer as parameter field pₐ (x, y, z . . . ) and can be used later as a reference at any time for calculations to be performed.

Depending on which sensor technology 27 is provided at the control unit 26, closing system parameters S of the closing system can be detected and stored as well. Such parameters to be determined can be the voltage, the motor speed, the pulse width measurement, or the temperature measured at the closing face 1. Based on the data on the immersion depth of the closing face 1 detected using empirical methods and the system state detected using the sensor technology 27, the real immersion depth

Eₓ=f(pₐ(S))

can be determined using the stored system parameters.

Depending on the value determined for the real immersion depth Eₓ, a shutoff position

P_{x,0}=f(Eₓ)

is determined. This position is selected in such a fashion that a safe closure of the closing face 1 is ensured, but so that the electric drive is stopped so prematurely that the closing face 1 to be closed comes to a standstill shortly before the real mechanical stop 9 is reached. A mechanical load of the drive components of the closing system that is too strong can be prevented in this fashion.

With a system adjustment as far as the upper mechanical stop 9 is concerned, comprising a door seal 5 embedded in a sheet metal profile 4, the electric drive of the closing face 1 is stopped when the shutoff position is reached, as long as the deviation of the determined shutoff position p_{x,0} with the expected new shutoff position p_{x,1} lies within a specifiable tolerance range.

The estimation of the new immersion depth takes place via an estimation of the expected immersion depth using the currently measured system parameters, S_{cur}, and the most recently stored system values S_{memory}.

dpₓ=pₐ(S_{cur})=pₐ(S_{memory})

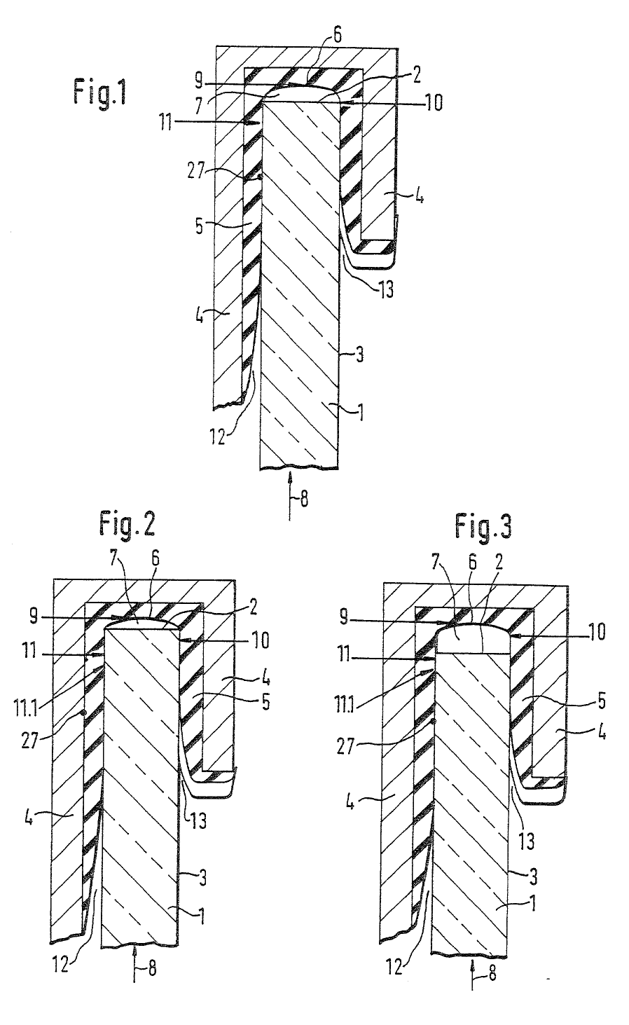

FIG. 2 shows a moving-in situation of a closing face with increasing immersion depth into the seal.

If an increased immersion depth results from the equation for dpₓ indicated above, then dpₓ>K₂. In this case, safe closure is given preference over the mechanical load alleviation of the components of the closing system. To increase the safety of closure, the shutoff position p_{x,0} is newly calculated, the electric drive is stopped when p_{x,0} is reached. If the immersion depth is above the known zero position 10, as shown in FIG. 2, the electric drive of the face to be closed is controlled until the blocking. The system parameters S are stored and the new standstill position for the subsequent adjusting cycle is calculated based on them. In the representation according to FIG. 2, it is obvious that the upper edge 2 of the driven closing face 1 has moved into the seal 5 past the zero position 10. Compared to the state represented in FIG. 1, the upper edge 2 of the closing face 1 is only moved further into the door seal 5; the hollow space 7 occurring between the upper edge 2 of the closing face 1 and the curvature 6 of the door seal 5 is designed much smaller.

FIG. 3 shows a moving-in situation of a closing face with decreasing immersion depth in the door seal in the door frame.

Depending on the system configuration, preference can be given to safe closure over alleviating the mechanical load on the components, or the closing system can be optimized in terms of “going easy” on the mechanical components. Within a safe tolerance range—safe in that a safe attainment of the closed position by the immersion of the upper edge 2 of the closing face 1 in the door seal within the tolerance range—the standstill position p_{x,0} calculated in previous adjusting cycle in each case is overrun, the system parameters S are stored, and the system is moved into the mechanical end position.

In this configuration, the upper edge 2 of the closing face 1 does not lie at the height of the zero position 10, but rather nearly parallel to the shutoff position 11 p_{x,0}; the new shutoff position p_{x,1} is identified and labelled with reference numeral 11.1. Since the upper edge 2 of the closing face 1 is not moved completely into the door seal 5, the hollow space 7 occurring between the curvature 6 of the door seal 5 and the upper edge 2 of the closing face 1 is designed larger as compared to the size of the hollow space in FIG. 2.

By specifically selecting and specifying the parameter values for K, K₁ and K₂, the system behavior of the closing system can be influenced in specific fashion. The parameters K, K₁ and K₂ can be varied. If the vehicle is locked from the outside by actuating the central locking mechanism, the parameters are adjusted in such a fashion that a safe closure of all faces is ensured. If the windows are closed from the inside of the vehicle, the mechanical load alleviation of the components can be given preference over safe closure by means of the selection of the values for K, K₁ and K₂.

During the service life of a closing system, mechanical changes that arise, e.g., play that occurs at the components, the window lifters or the like, or at transmitting elements assigned to these, can influence the system behavior. For this reason, the mechanical stops are approached at defined time intervals, the shutoff of the respective electric drive for braking the forward motion of the closing face 1 in the direction 8 at the calculated shutoff position p_{x,0} is suppressed; the determination of this approach interval can take place empirically, and the updating of the system change can be determined based on the sum of the adjustment travels covered by the closing face 1. In addition to drawing upon the overall adjustment travel covered, the number of soft stops actuated so far—that is, the specific, timely shutoff of the electric drive—can be also be drawn upon for the determination.

A closing system can be moved into its respective mechanical end positions 9 more often in the beginning, for instance. As the number of adjustment cycles increases, such a moving into position occurs less frequently. Conversely, as the service life of the closing system increases, a more frequent moving into of the mechanical end position 9 can take place, in order to eliminate play that may develop in the components of the closing system, or to take it into consideration in the calculations of the respective stop or shutoff positions.

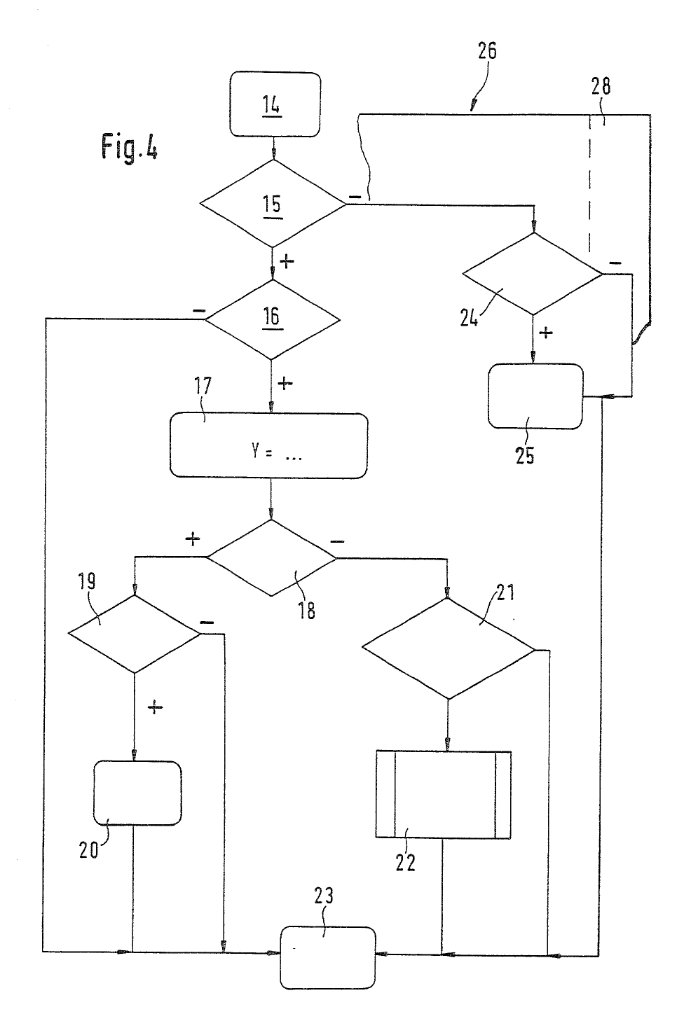

FIG. 4 shows, as an example, the query and calculation routines taking place in a control unit contained in at least one memory, shown here for a lower stop of a closing face 1.

After the start of the calculation routine for the determination of an adaptive soft stop for a lower stop after the starting point 14, the query 15 of a lower stop position takes place at first. The lower stop position can be known, or it can be determined using a reference run. If this is not known, a branching off to a query 24 takes place, which asks if the lower stop has been reached. If the answer is “no”, the lower contact position is set as the current position in the parameter specification 25, the predicted value is set to X. If the lower stop has not been reached, however, a branching off of the calculation routine to the end point 23 takes place.

Starting from the query 15, a branching off to query 16 takes place, which asks if a current lowering is present or not. If the answer is “no”, a branching off to the end position 23 takes place until the next cyclic call for the calculation routine at position 14.

If a lowering motion of the closing face 1 is present, the difference y is calculated, which results from the difference between the stored stop position and the current standstill position. If the electric drive is switched on—which results from a query 18—a comparison of the difference y with the current predicted value takes place. If the difference y is less than the predicted value, the electric drive is stopped. If not, a branching off from the predicted value comparison 19 to the end 23 of the calculation routine takes place.

If the answer to the query 18 regarding the status of the electric drive is that it is switched off, the correction 21, 22 of the predicted value is initiated, which takes place in an arithmetic block 22. When the next lowering motion takes place, a new predicted value is used as the basis for the calculation of the shutoff position. The shutoff position can be corrected by means of cyclical or acyclical approaching and/or overrunning of the stops. System-induced changes, e.g., expansion change of mechanical components or changes in the adjustment travel, can be determined as a result, as explained already in the context of FIGS. 1, 2 and 3.

### LIST OF REFERENCE SYMBOLS

1 Window pane

2 Upper edge

3 Outer surface

4 Door frame

5 Seal

6 Curvature

7 Hollow space

8 Driving direction

9 Physical zero point p₁

10 Actual current zero point p₂

11 Shutoff position p_{x,0}

11.1 New shutoff position p_{x,1}

12 Inlet slant

13 Starting position

14 Lower stop position query

15 Lowering query

16 y difference stop position—current position

17 Drive query

18 Difference y query

19 Drive control

20 System state query

21 Predicted value calculation routine

22 Routine end point

23 Arrival at lower stop query

24 Stop position, predicted value parameter entry

25 Control unit

26 Sensor technology

27 Memory

A Stop position

pₐ Shutoff position

S System parameter

1. Method for the contactless approaching of fixed upper stop position A outfitted with a seal (5) by a window pane (1) of a motor vehicle actuated by external force, wherein, when an upper window-pane edge (2) approaches the stop position (A), a control signal is generated by a control unit (26), by way of which the drive is switched off in a shutoff position pₐ (and/or its driving direction is changed), so that the upper window-pane edge (2) comes to a standstill in a zero position p₀, characterized in that
when the window pane approaches the stop position A, system parameters (S₁ . . . Sₙ) are detected by sensors (27) and stored in a memory (28),
a system state S_{z} (S₁-Sₙ) dependent on the system parameters of (S₁ . . . Sₙ) with the shutoff position pₐ is read out from a characteristic diagram,
a comparison between the current system state SZ_{cur}(S₁-Sₙ) in each case and a reference system state SZ_{ref}(S₁ . . . Sₙ) stored in the memory 28 is carried out, in particular a difference is calculated and a deviation ΔSZ is determined, and
a new shutoff position p_{anew} is calculated based on the deviation ΔSZ determined.

2. Method according to claim 1, characterized in that variable system parameters (S₁-Sᵥ), in particular, motor torque, temperature of the windows or seal environment, motor voltage, seal friction, kinetic system energy, are detected by the sensors (27).

3. Method according to claim 1 or 2, characterized in that fixed system parameters (S₁-S_{f}), in particular, the seal geometry, the window-pane surface, the door geometry or concerning the like are specified or can be specified.

4. Method according to one of the claims 1 through 3, characterized in that the immersion depth of the upper edge of the window pane (2) into the seal (5) is identified as system state from the parameter field.

5. Method according to claim 1, characterized in that the interrelationship between the zero position (10) p₀ approached by the window pane (1) and the system states (S₁-Sₙ) are determined empirically in advance, and the characteristic diagram Pₐ(S₁-Sₙ) is stored in the memory (28).

6. Method according to claim 1, characterized in that voltmeters, tachometers, pulse width meters, temperature detectors or the like are used as sensors (27).

7. Method according to claim 1, characterized in that the zero position (10) P₀, P_{0′} is calculated by the control unit (26) on the basis of the current system parameters S₁-Sₙ and the characteristic diagram Pₐ(S₁-Sₙ) stored in the memory.

8. Method according to claim 1, characterized in that, with a deviation dpa, the new shutoff position (11.1) p_{a′} is equal to the previous shutoff position (11) pₐ.

9. Method according to claim 1, characterized in that, when the deviation dpa is greater than zero and less than a tolerance limit T, the new shutoff position (11.1) P_{a′} is equal to the previous shutoff position (11) pₐ.

10. Method according to claim 7, characterized in that the acceptance width T corresponds to 0.5-1 armature rotations.

11. Method according to claim 1, characterized in that, if the zero position (10) p₀ is overrun by the window-pane edge (2) as detected by the control unit (26), the deviation dpa becomes more equal than 0.

12. Method according to claim 9, characterized in that, with a deviation dpa less than a tolerance limit T and greater than a reference limit K₂, the window-pane edge (2) is moved into a blocking against the fixed stop position (9) (A), and the zero position P_{2′} is newly established as a function of the stop position (9), (A).

13. Method according to claim 9, characterized in that, with a deviation dpa less than a tolerance limit T and greater than a reference value R, the shutoff position (11) pₐ is corrected so that the new shutoff position (11.1) p_{a′} lies closer to the fixed stop position (9) (A).

14. Method according to claim 1, characterized in that, when the zero position (10) p₀ is not reached by the window-pane edge (2), as determined by the control unit (26), the deviation dpa becomes greater than 0.

15. Method according to claim 12, characterized in that, with a deviation dpa greater than a tolerance limit T and less than a first reference value R, the shutoff position (11) pₐ is corrected so that the new shutoff position (11.1) p_{a′} lies further away from the fixed stop position (9) (A).

16. Method according to claim 12, characterized in that, with a deviation dpa greater than a first reference value R₁ and less than a second reference value R₂, the shutoff position (11) pₐ is not corrected, and the window pane (1) moves through the seal (5) into a blocking.
